(19) United States
(12) Patent Application Publication
(10) Pub. No.: US 2017/0347681 A1
(43) Pub. Date: Dec. 7, 2017

(54) PASTE-LIKE OILY FOODSTUFF

(71) Applicant: FUJI OIL HOLDINGS INC., OSAKA (JP)

(72) Inventor: Akiyuki ISHIWATA, IBARAKI (JP)

(73) Assignee: FUJI OIL HOLDINGS INC., OSAKA (JP)

(21) Appl. No.: 15/541,474

(22) PCT Filed: Jan. 7, 2016
(86) PCT No.: PCT/JP2016/050380

§ 371 Date: Jul. 4, 2017

(30) Foreign Application Priority Data
Feb. 16, 2015 (JP) 2015-027492

(51) Int. Cl. A23G 3/40; A23G 1/36

(52) U.S. Cl. CPC A23G 3/40; A23G 1/36

(57) ABSTRACT

The present invention addresses the problem of providing a paste-like oily foodstuff that contains a preset amount of fats and oils, can be easily handled during preparation and yet has a heat resistance and favorable melting feeling in the mouth. The above problem has been solved by finding that a paste-like oily foodstuff, in which the yield value is increased without increasing the plastic viscosity, can be obtained by using a specific emulsifier and the thus obtained paste-like oily foodstuff has a heat resistance, favorable melting feeling in the mouth and good handling properties during preparation.

### TECHNICAL FIELD

The present invention relates to a paste-like oily foodstuff having heat resistance.

### BACKGROUND ART

A paste-like foodstuff containing fats and oils, that is, a “paste-like oily foodstuff” is widely used for fillings of confectionery, bread, or the like.

In order to increase the heat resistance of fillings, fats and oils having a high melting point may be used.

In addition, in Patent Literature 1, it is described that problems are solved using fine dietary fibers and the like.

In Patent Literature 2, it is described that “a heat resistant filling material satisfying the above conditions can be obtained when a specific raw starch is used and deacyl gellan gum and a soluble calcium salt are included in combination.”

In Patent Literature 3, an emulsifier is used to increase the heat resistance of a filling. Here, it is described that “when an emulsifier having an HLB of 10 or more is used in a formulation, and is mixed in and dispersed using an emulsifying machine such as a homomixer for preparation,” problems can be solved.

### CITATION LIST

### Patent Literature

[Patent Literature 1]

Japanese Unexamined Patent Application No. 2005-185258
[Patent Literature 2]

Japanese Unexamined Patent Application No. 2005-102617
[Patent Literature 3]

Japanese Unexamined Patent Application No. H7-39308

### SUMMARY OF INVENTION

### Technical Problem

The present invention provides a paste-like oily foodstuff that contains a certain amount of fats and oils, has heat resistance despite of the fact that handling is easy during preparation, and provides a favorable melting feeling in the mouth.

### Solution to Problem

The inventors conducted extensive research to solve certain problems. When fats and oils having a high melting point are used in order to increase the heat resistance of paste-like oily foodstuffs, it is difficult to provide a favorable melting feeling in the mouth in many cases.

In a paste-like oily foodstuff such as a filling, as described in Patent Literature 1 and 2, when fibrous or starch materials were added, since the viscosity increased during preparation, handling was difficult in some cases.

In Patent Literature 3, although a temperature at which the fats and oils were used is not clearly described, it may be assumed that fats and oils having a melting point at which liquidity was caused at about 35 to 40° C. were used based on the specification. This failed to correspond to an object of the present invention of obtaining a paste-like oily foodstuff providing a favorable melting feeling in the mouth.

Therefore, the related art fails to serve as a reference for solving the problems of the present invention.

The inventors conducted further research.

In this research, it was found that, in a paste-like oily foodstuff, when a yield value was high, a heat resistance increased. However, when a yield value was increased merely for formulation, a plastic viscosity also increased. As a result, handling properties during preparation deteriorated and thus the problems were not solved.

Accordingly, it was investigated whether there is a substance having properties in which a yield value increases and an increase in plastic viscosity is minimized. As a result, it was found that a specific emulsifier had effects of increasing a yield value and not increasing a plastic viscosity when a paste-like oily foodstuff was formulated. Then, it was found that the problems can be solved when such an emulsifier was appropriately used in a formulation, and the present invention was completed.

That is, the present invention relates to the following,
(1) A paste-like oily foodstuff which has an oil content of 26 to 70 weight %, contains an emulsifier, and has, at 40° C., a yield value of 32 to 60 Pa, a plastic viscosity of 0.3 to 1.3, and yield value/plastic viscosity of 30 to 70.
(2) The paste-like oily foodstuff according to (1), wherein the oil content is 26 to 40 weight %.
(3) The paste-like oily foodstuff according to (1), wherein the yield value is 37 to 50 Pa.
(4) The paste-like oily foodstuff according to (1), wherein the plastic viscosity is 0.5 to 1.
(5) The paste-like oily foodstuff according to (1), wherein yield value/plastic viscosity is 38 to 60.
(6) The paste-like oily foodstuff according to (1), wherein the oil content is 26 to 40. weight %, the emulsifier is contained, and at 40° C., the yield value is 37 to 50 Pa, the plastic viscosity is 0.5 to 1, and yield value/plastic viscosity is 38 to 60.
(7) The paste-like oily foodstuff according to any of (1) to (6), wherein the emulsifier is a sorbitol type sorbitan mono fatty acid ester having an HLB of 5 to 10, which is contained at 0.2 to 2.5 weight %.
(8) The paste-like oily foodstuff according to (7), wherein a fatty acid of the sorbitol type sorbitan mono fatty acid ester is a saturated type.
(9) The paste-like oily foodstuff according to any one of (1) to (6), wherein the emulsifier is a distilled diglycerin mono fatty acid ester having an HLB of 5 to 10, which is contained at 0.2 to 5 weight %.
(10) A method of preparing a paste-like oily foodstuff in which a sorbitol type sorbitan mono fatty acid ester having an HLB of 5 to 10 is contained at 0.2 to 2.5 weight %, an oil content is 26 to 70 weight %, and at 40° C., a yield value is 32 to 60 Pa, a plastic viscosity is 0.3 to 1.3, and yield value/plastic viscosity is 30 to 70.
(11) The method of preparing a paste-like oily foodstuff according to (10), wherein the sorbitol type sorbitan mono fatty acid ester having an HLB of 5 to 10 is contained at 0.2 to 2.5 weight %, the oil content is 26 to 40 weight %, and at 40° C., the yield value is 37 to 50 Pa, the plastic viscosity is 0.5 to 1, and yield value/plastic viscosity is 38 to 60.
(12) The method of preparing a paste-like oily foodstuff according to (10) or (11), wherein a fatty acid of the sorbitol type sorbitan mono fatty acid ester is a saturated type.
(13) A method of preparing a paste-like oily foodstuff in which a distilled diglycerin mono fatty acid ester having an HLB of 5 to 10 is contained at 0.2 to 5 weight %, an oil content is 26 to 70 weight %, and at 40° C., a yield value is 32 to 60 Pa, a plastic viscosity is 0.3 to 1.3, and yield value/plastic viscosity is 30 to 70.
(14) The method of preparing a paste-like oily foodstuff according to (13), wherein a distilled diglycerin mono fatty acid ester having an HLB of 5 to 10 is contained at 0.2 to 5 weight %, the oil content is 26 to 40 weight %, and at 40° C., the yield value is 37 to 50 Pa, the plastic viscosity is 0.5 to 1, and yield value/plastic viscosity is 38 to 60.
(15) A method of imparting heat resistance to a paste-like oily foodstuff in which a sorbitol type sorbitan mono fatty acid ester having an HLB of 5 to 10 is contained at 0.2 to 2.5 weight % and an oil content is 26 to 70 weight %.
(16) The method of imparting heat resistance according to (15) to a paste-like oily foodstuff having an oil content of 26 to 40 weight %.
(17) A method of imparting heat resistance to a paste-like oily foodstuff in which a distilled diglycerin mono fatty acid ester having an HLB of 5 to 10 is contained at 0.2 to 5 weight % and an oil content is 26 to 70 weight %.
(18) The method of imparting heat resistance according to (17) to a paste-like oily foodstuff having an oil content of 26 to 40 weight %.

In addition, in other words, the present invention relates to the following,
(19) A paste-like oily foodstuff which has an oil content of 26 to 70 weight %, contains an emulsifier, and has, at 40° C., a yield value of 32 to 60 Pa, a plastic viscosity of 0.3 to 1.3, and yield value/plastic viscosity of 30 to 70.
(20) The paste-like oily foodstuff according to (19),

wherein the emulsifier is a sorbitol type sorbitan mono fatty acid ester having an HLB of 5 to 10, which is contained at 0.2 to 2.5 weight %.
(21) The paste-like oily foodstuff according to (20),

wherein a fatty acid of the sorbitol type sorbitan mono fatty acid ester is a saturated type.
(22) The paste-like oily foodstuff according to (19),

wherein the emulsifier is a distilled diglycerin mono fatty acid ester having an HLB of 5 to 10, which is contained at 0.2 to 5 weight %.
(23) A method of preparing a paste-like oily foodstuff in which a sorbitol type sorbitan mono fatty acid ester having an HLB of 5 to 10 is contained at 0.2 to 2.5 weight %, an oil content is 26 to 70 weight %, and at 40° C., a yield value is 32 to 60 Pa, a plastic viscosity is 0.3 to 1.3, and yield value/plastic viscosity is 30 to 70.
(24) The method of preparing a paste-like oily foodstuff according to (23),

wherein a fatty acid of the sorbitol type sorbitan mono fatty acid ester is a saturated type.
(25) A method of preparing a paste-like oily foodstuff in which a distilled diglycerin mono fatty acid ester having an HLB of 5 to 10 is contained at 0.2 to 5 weight %, an oil content is 26 to 70 weight %, and at 40° C., a yield value is 32 to 60 Pa, a plastic viscosity is 0.3 to 1.3, and yield value/plastic viscosity is 30 to 70.
(26) A method of imparting heat resistance to a paste-like oily foodstuff in which a sorbitol type sorbitan mono fatty acid ester having an HLB of 5 to 10 is contained at 0.2 to 2.5 weight % and an oil content is 26 to 70 weight %.
(27) A method of imparting heat resistance to a paste-like oily foodstuff in which a distilled diglycerin mono fatty acid ester having an HLB of 5 to 10 is contained at 0.2 to 5 weight % and an oil content is 26 to 70 weight %.

### Advantageous Effects of Invention

According to the present invention, it is possible to obtain a paste-like oily foodstuff which has heat resistance despite of the fact that handling is easy during preparation, and provides a favorable melting feeling in the mouth.

### DESCRIPTION OF EMBODIMENTS

A paste-like oily foodstuff in the present invention is a pasty foodstuff containing fats and oils. Here, an amount of fats and oils is preferably 26 to 70 weight %, more preferably 26 to 60 weight %, and most preferably 26 to 40 weight %.

When an appropriate amount of fats and oils having appropriate melting points is used, it is possible to obtain a paste-like oily foodstuff providing a favorable melting feeling in the mouth.

As fats and oils used in the present invention, various types of edible fats and oils can be exemplified. In the present invention, although fats and oils having a melting point in a relatively wide range can be used, in order to provide a favorable melting feeling in the mouth to the paste-like oily foodstuff, a melting point in an oil phase thereof is preferably 35° C. or less, and more preferably 30° C. or less. In particular, the present invention is characterized in that a melting point in an oil phase in the paste-like oily foodstuff has a small influence on heat resistance, and even if a melting point in an oil phase is 15° C. or less, the problems of the present invention can be solved.

A melting point in an oil phase is obtained by extracting an oil content from an oily foodstuff according to the present invention and measuring the melting point. Also, the melting point herein is a rising melting point and is measured according to “JOCS Standard Methods for the Analysis of Fats, Oils and Related Materials”(1) (1996 version) The Japan Oil Chemist's Society.

In the paste-like oily foodstuff according to the present invention, at 40° C., a yield value is 32 to 60 Pa, a plastic viscosity is 0.3 to 1.3, and yield value/plastic viscosity is 30 to 70.

The yield value is preferably 35 to 60 Pa, and more preferably 37 to 50 Pa.

The plastic viscosity is preferably 0.4 to 1.1, and more preferably 0.5 to 1. Also, yield value/plastic viscosity is preferably 35 to 70, and more preferably 38 to 60.

When the yield value and the plastic viscosity are set to appropriate values, it is possible to obtain a paste-like oily foodstuff having both favorable handling properties and required physical properties such as heat resistance.

Accordingly, a paste-like oily foodstuff having such physical properties can be obtained using a specific emulsifier. The emulsifier is specifically a sorbitol type sorbitan mono fatty acid ester having an HLB of 5 to 10. This is preferably contained at 0.2 to 2.5 weight %. Therefore, a fatty acid of the sorbitol type sorbitan mono fatty acid ester is preferably a saturated type.

In addition, as the emulsifier, a distilled diglycerin mono fatty acid ester having an HLB of 5 to 10 is used. When this is contained at 0.2 to 5 weight %, a preferable form is obtained.

When such a preferable emulsifier is used, it is possible for physical properties required in a paste-like oily foodstuff to be exhibited, thereby solving the problems of the present invention. Also, a combination of these preferable emulsifiers may be appropriately used without limitation.

In the present invention, easy handling during preparation means a property in which a liquid can be transferred by a general pump when the paste-like oily foodstuff according to the present invention is prepared. Specifically, it means that the viscosity is 47 Pa·s or less (value measured using a BM type viscometer (No. 4 rotor and 12 rpm) commercially available from Toki Sangyo Co., Ltd.) at 40° C. At such a viscosity, a liquid can be transferred by a general pump, and easy preparation is possible without causing clogging of a pipe during preparation.

In general, heat resistance can be imparted by reducing a formulation amount of oil content in an oily foodstuff in some cases. However, if the viscosity at 40° C. increases, it is difficult to transfer a liquid by a pump, and preparation is not easy in some cases.

The heat resistance in the paste-like oily foodstuff of the present invention refers to a property in which, even if bread or confectionery using the foodstuff as a filling or the like is distributed in the middle of summer, the product is not damaged due to flowing out or the like. This is based on heat resistance at 50° C. assuming distribution in the middle of summer, and particularly, the inside of cargo compartments of trucks, containers, or the like at high temperatures. Specific evaluation methods are described in the examples.

Specific examples of the paste-like oily foodstuff of the present invention include butter cream and chocolate cream. Both are oily foodstuffs in which fats and oils are in a continuous phase. Since the effects of the present invention are obtained to a high degree by controlling physical properties of fats and oils using an emulsifier, the effect is significantly exhibited in a paste-like oily foodstuff in which fats and oils are in a continuous phase. In particular, in an anhydrous type paste-like oily foodstuff in which water is not used as a raw material, the effect is significantly exhibited.

Among the above paste-like oily foodstuff, this particularly appropriately applies to chocolate cream. This is because, since a certain amount of carbohydrates derived from cocoa and the like are already contained in chocolate cream, when fiber components and the like are additionally added in order to impart heat resistance, handling properties during preparation significantly deteriorate.

Also, chocolate cream contains fats and oils, a cacao raw material, and saccharides and exhibits spreading properties at room temperature. The cacao raw material is specifically cocoa or cacao mass. Examples of the saccharides include sugars such as lactose. In addition, as necessary, powdered milk is included. As the powdered milk, skimmed milk powder and whole milk powder can be exemplified.

The paste-like oily foodstuff in the present invention can be prepared by adding an appropriate amount of a predetermined emulsifier to fats and oils used in a general preparation method of butter cream or chocolate cream. In addition, even if an emulsifier other than a sorbitol type sorbitan mono fatty acid ester having an HLB of 5 to 10 and a distilled diglycerin mono fatty acid ester having an HLB of 5 to 10 is used, it is possible to select an appropriate emulsifier using values of physical properties such as a yield value and a plastic viscosity as determination criteria.

In addition, similarly to the above, a method of imparting heat resistance to a paste-like oily foodstuff in the present invention includes adding an appropriate amount of a predetermined emulsifier to fats and oils used when the paste-like oily foodstuff is prepared.

### EXAMPLES

### Examination 1 Screening of Emulsifiers

### Examples 1 to 5 and Comparative Examples 1 to 9

Screening of emulsifiers was performed according to the formulations shown in Table 1.

Preparation methods of an oily foodstuff and methods of measuring physical property values were as follows. The results are shown in Table 1.

TABLE 1
Formulations and physical property values of oily foodstuffs

| | Oil content | | | | | | Comparative | Comparative |
|---|---|---|---|---|---|---|---|---|
| | (weight %) | Example 1 | Example 2 | Example 3 | Example 4 | Example 5 | Example 1 | Example 2 |
| Sugar | | 44.0 | 44.0 | 44.0 | 44.0 | 44.0 | 44.0 | 44.0 |
| Cocoa | 11.0 | 16.5 | 16.5 | 16.5 | 16.5 | 16.5 | 16.5 | 16.5 |
| Skimmed | 1.0 | 9.8 | 9.8 | 9.8 | 9.8 | 9.8 | 9.8 | 9.8 |
| milk powder | | | | | | | | |
| Cacao mass | 55.0 | 1.9 | 1.9 | 1.9 | 1.9 | 1.9 | 1.9 | 1.9 |
| Super palm | 100.0 | 27.1 | 27.1 | 27.1 | 27.1 | 27.1 | 27.6 | 27.3 |
| olein | | | | | | | | |
| Hyaluric acid | 100.0 | | | | | | | 0.3 |
| rapeseed oil | | | | | | | | |
| extremely | | | | | | | | |
| hard oil | | | | | | | | |
| Lecithin | — | 0.2 | 0.2 | 0.2 | 0.2 | 0.2 | 0.2 | 0.2 |
| Emulsifier | — | POEM | L-300 | POEM | EMASOL | SolmanS- | | |
| (trade name) | | DL-100 | | DS-100A | L10V | 300V | | |
| Amount | — | 0.5 | 0.5 | 0.5 | 0.5 | 0.5 | | |
| added | | | | | | | | |
| Manufacturer | — | Riken | Riken | Riken | Kao | Riken | | |
| | | Vitamin | Vitamin | Vitamin | | Vitamin | | |
| Emulsifier | — | Distilled | Monolaurate | Diglycerin | Sorbitan | Monostearate | | |
| classification | | diglycerin | (sorbitol | monostearate | monolaurate | (sorbitol type) | | |
| | | monolaurate | type) | | | | | |
| HLB | — | 9.4 | 8.0 | 7.7 | 8.6 | 5.3 | | |
| Hydroxyl | — | | 460-500 | | 330-358 | 315-345 | | |
| value | | | | | | | | |
| (sorbitan) | | | | | | | | |
| Total | — | 100.0 | 100.0 | 100.0 | 100.0 | 100.0 | 100.0 | 100.0 |
| Oil content | — | 30.1 | 30.1 | 30.1 | 30.1 | 30.1 | 30.6 | 30.6 |
| (weight %) | | | | | | | | |
| Melting point | — | 11° C. | 11° C. | 13° C. | 11° C. | 12° C. | 11° C. | 13° C. |
| in oil phase | | | | | | | | |
| Viscosity | — | 34 | 31 | 27.5 | 30 | 29.5 | 27.5 | 34 |
| (Pa · s) at | | | | | | | | |
| 40° C. | | | | | | | | |
| Yield value | — | 49.11 | 40.67 | 38.14 | 37.43 | 38.61 | 30.11 | 29.45 |
| (Pa) at 40° C. | | | | | | | | |
| Plastic | — | 0.85 | 0.83 | 0.93 | 0.97 | 0.76 | 1.44 | 1.67 |
| viscosity | | | | | | | | |
| (Pa · s) | | | | | | | | |
| Yield | — | 57.66 | 48.78 | 41.07 | 38.76 | 50.64 | 20.88 | 17.68 |
| value/plastic | | | | | | | | |
| viscosity | | | | | | | | |
| | Oil content | Comparative | Comparative | Comparative | Comparative | Comparative | Comparative | Comparative |
| | (weight %) | Example 3 | Example 4 | Example 5 | Example 6 | Example 7 | Example 8 | Example 9 |
| Sugar | | 44.0 | 44.0 | 44.0 | 44.0 | 44.0 | 44.0 | 44.0 |
| Cocoa | 11.0 | 16.5 | 16.5 | 16.5 | 16.5 | 16.5 | 16.5 | 16.5 |
| Skimmed | 1.0 | 9.8 | 9.8 | 9.8 | 9.8 | 9.8 | 9.8 | 9.8 |
| milk powder | | | | | | | | |
| Cacao mass | 55.0 | 1.9 | 1.9 | 1.9 | 1.9 | 1.9 | 1.9 | 1.9 |
| Super palm | 100.0 | 27.1 | 27.1 | 27.1 | 27.1 | 27.1 | 27.1 | 27.1 |
| olein | | | | | | | | |
| Lecithin | — | 0.2 | 0.2 | 0.2 | 0.2 | 0.2 | 0.2 | 0.2 |
| Emulsifier | — | ER290 | S070 | S770 | POEM S60V | POEM | EMASOL | EMASOL- |
| (trade name) | | | | | | O80V | S30V | MS |
| Amount | — | 0.5 | 0.5 | 0.5 | 0.5 | 0.5 | 0.5 | 0.5 |
| added | | | | | | | | |
| Manufacturer | — | Mitsubishi- | Mitsubishi- | Mitsubishi- | Riken | Riken | Kao | Riken |
| | | Chemical | Chemical | Chemical | Vitamin | Vitamin | | Vitamin |
| | | Foods | Foods | Foods | | | | |
| | | Corporation | Corporation | Corporation | | | | |
| Emulsifier | — | Sugar ester | Sugar ester | Sugar ester | Sorbitan | Sorbitan | Sorbitan | Distilled |
| classification | | | | | monostearate | monooleate | tristearate | monoglycerin |
| | | | | | | | | fatty acid |
| | | | | | | | | monoester |
| HLB | — | About 2 | 1 or less | About 7 | 5.1 | 4.9 | 2.1 | 4.3 |
| Hydroxyl | — | | | | 235-260 | 193-209 | 235-260 | |
| value | | | | | | | | |
| (sorbitan) | | | | | | | | |
| Total | — | 100.0 | 100.0 | 100.0 | 100.0 | 100.0 | 100.0 | 100.0 |
| Oil content | — | 30.1 | 30.1 | 30.1 | 30.1 | 30.1 | 30.1 | 30.1 |
| (weight %) | | | | | | | | |
| Melting point | — | 11° C. | 12° C. | 11° C. | 12° C. | 11° C. | 12° C. | 13° C. |
| in oil phase | | | | | | | | |
| Viscosity | — | 29.50 | 30.00 | 12.00 | 20.00 | 16.50 | 26.50 | 22.50 |
| (Pa · s) at | | | | | | | | |
| 40° C. | | | | | | | | |
| Yield value | — | 11.14 | 20.79 | 19.04 | 31.07 | 26.97 | 28.48 | 31.18 |
| (Pa) at 40° C. | | | | | | | | |
| Plastic | — | 0.78 | 1.12 | 0.92 | 0.97 | 0.99 | 1.15 | 1.10 |
| viscosity | | | | | | | | |
| (Pa · s) | | | | | | | | |
| Yield | — | 14.28 | 18.62 | 20.74 | 31.94 | 27.17 | 24.81 | 28.43 |
| value/plastic | | | | | | | | |
| viscosity | | | | | | | | |

(Unit in formulation is weight %)

As a palm super olein, “Palm Ace 10” commercially available from Fuji Oil Co., Ltd. having a melting point of 10° C. was used.

As fat and oil raw materials, a super palm olein and hyaluric acid rapeseed oil extremely hard oil were used.

### “Preparation Method of Oily Foodstuffs”

1. According to the formulation table, cacao mass, cocoa, skimmed milk powder, sugar, soybean lecithin, and 3/4 of a fat and oil raw material melted mixture were mixed using a mixer having a warm water jacket, and a dough having moderate hardness at 50° C. was obtained.
2. The dough was atomized by a roll refiner and a particle size was adjusted to about 17 to 23 μ using a micrometer.
3. While kneading in a conche, the dough was mixed with the remaining fat and oil raw material melted mixture to prepare oily foodstuffs. Here, in a conche, an emulsifier other than lecithin was heated and mixed with the remaining fat and oil raw material melted mixture, melted and added.
4. The sample was left at room temperature for 12 hours or longer.

### “Method of Measuring Viscosity”

1. Oily foodstuff was warmed to 60° C. and completely melted.
2. The sample was left at room temperature and cooled to 40° C.
3. The viscosity was measured using a BM type viscometer (12 rpm and No. 4 rotor) commercially available from Toki Sangyo Co., Ltd.
4. When the viscosity was 47 Pa·s or less, this was determined to be satisfactory.

### “Method of Measuring Yield Value and Plastic Viscosity”

1. Oily foodstuff was warmed to 60° C. and completely melted.
2. The sample was left at room temperature and cooled to 40° C.
3. A shear stress was measured using a Rheolab-QC (commercially available from AntonPaar) at 40° C. and a shear rate of 2(1/s) to 50(1/s).
4. A yield value and a plastic viscosity were calculated by a mathematical expression using the Casson approximation formula.

### Results

As shown in Table 1, it was confirmed that, when a specific emulsifier was used, required physical property values were exhibited.

### Examination 2 Evaluation of Oily Foodstuffs

Heat resistance evaluation and sensory evaluation of the oily foodstuffs obtained in Examination 1 were performed.

The evaluation methods were as follows.

The results are shown in Table 2.

### “Heat Resistance Evaluation Method”

1. Each oily foodstuff obtained in Examination 1 was put into a pastry bag and squeezed into a plastic container (φ 8 cm) in a flower pattern.
2. While the plastic container in the above procedure 1 was covered with a lid, the samples were put into incubators at various temperatures and left for 24 hours. A sample left at 20° C. was used as a control.
3. States after being left were evaluated based on the following criteria and it was checked whether the sample had heat resistance.
5 points: edge conditions and a height were the same as those in the control.
4 points: edge conditions and a height were slightly inferior to those of the control, but the difference was hardly recognizable.
3 points: edge conditions and a height were slightly inferior to those of the control and were easily recognizable.
2 points: edge conditions and a height were clearly inferior to those of the control.
1 point: hardly any of the original form was maintained.

After storing at 50° C., a grade of 4 points or higher was determined to be satisfactory.

### “Sensory Evaluation Method”

1. Each oily foodstuff obtained in Examination 1 was put into a pastry bag and squeezed into a plastic container (φ 8 cm) in a flower pattern.
2. The sample was left at room temperature (18 to 22° C.) for 1 hour.
3. The samples were tested by five panelists and scored based on the following criteria in comparison with Comparative Example 1. Here, Comparative Example 1 was a sample providing favorable melting feeling in the mouth and scored as 3 points.
3 points: melting feeling in the mouth favorable without discomfort.
2 points: somewhat bad melting feeling in the mouth.
1 point: obvious bad melting feeling in the mouth and tasteless.
3 points was determined as being satisfactory.

TABLE 2
Results

| | | | | | | Comparative | Comparative |
|---|---|---|---|---|---|---|---|
| | Example 1 | Example 2 | Example 3 | Example 4 | Example 5 | Example 1 | Example 1 |
| Heat resistance | 5 | 5 | 5 | 5 | 5 | 1 | 4 |
| evaluation | | | | | | | |
| (40° C.) | | | | | | | |
| Heat resistance | 5 | 5 | 5 | 5 | 5 | 1 | 3 |
| evaluation | | | | | | | |
| (50° C.) | | | | | | | |
| Heat resistance | 4 | 4 | 4 | 4 | 4 | 1 | 2 |
| evaluation | | | | | | | |
| (60° C.) | | | | | | | |
| Heat resistance | 4 | 4 | 4 | 4 | 4 | 1 | 1 |
| evaluation | | | | | | | |
| (70° C.) | | | | | | | |
| Melting feeling | 3 | 3 | 3 | 3 | 3 | 3 | 2 |
| in the mouth | | | | | | | |
| | Comparative | Comparative | Comparative | Comparative | Comparative | Comparative | Comparative |
| | Example 3 | Example 4 | Example 5 | Example 6 | Example 7 | Example 8 | Example 9 |
| Heat resistance | 1 | 3 | 2 | 2 | 1 | 2 | 3 |
| evaluation | | | | | | | |
| (40° C.) | | | | | | | |
| Heat resistance | 1 | 2 | 1 | 1 | 1 | 1 | 2 |
| evaluation | | | | | | | |
| (50° C.) | | | | | | | |
| Heat resistance | 1 | 1 | 1 | 1 | 1 | 1 | 1 |
| evaluation | | | | | | | |
| (60° C.) | | | | | | | |
| Heat resistance | 1 | 1 | 1 | 1 | 1 | 1 | 1 |
| evaluation | | | | | | | |
| (70° C.) | | | | | | | |
| Melting feeling | 3 | 3 | 3 | 3 | 3 | 3 | 3 |
| in the mouth | | | | | | | |

As shown in Table 2, the oily foodstuff exhibiting specific physical property values had both favorable handling properties during preparation, heat resistance and favorable melting feeling in the mouth during eating, which can solve the problems of the present invention.

### Examination 3 Evaluation of Various Types of Oily Foodstuffs

### Examples 6 to 7 and Comparative Examples 10 to 14

According to the formulation table (Table 3), in the same manner as in Examination 1, various types of oily foodstuffs were prepared and physical property values were measured. The results are summarized in Table 3.

In addition, in the same manner as in Examination 1, heat resistance evaluation and sensory evaluation were performed. The results are shown in Table 4.

TABLE 3
Formulation table

| | Oil | | | | | | | |
|---|---|---|---|---|---|---|---|---|
| | content | | | Comparative | Comparative | Comparative | Comparative | Comparative |
| | (weight %) | Example 6 | Example 7 | Example 10 | Example 11 | Example 12 | Example 13 | Example 14 |
| Sugar | | 23.8 | 23.8 | 49.2 | 44.0 | 23.6 | 23.6 | 23.6 |
| Lactose | | 20.0 | 20.0 | | | 20.0 | 20.0 | 20.0 |
| Cocoa | 11.0 | 10.0 | 10.0 | 16.5 | 16.5 | 10.0 | 10.0 | 10.0 |
| Skimmed | 1.0 | | | 9.8 | 9.8 | | | |
| milk powder | | | | | | | | |
| Whole milk | 26.2 | 18.0 | 18.0 | | | 18.0 | 18.0 | 18.0 |
| powder | | | | | | | | |
| Cacao mass | 55.0 | | | 1.9 | 1.9 | | | |
| Super palm | 100.0 | | | 22.4 | 26.0 | | | |
| olein | | | | | | | | |
| Hyaluric acid | 100.0 | | | | 1.6 | | | |
| rapeseed oil | | | | | | | | |
| extremely | | | | | | | | |
| hard oil | | | | | | | | |
| High oleic | 100.0 | 27.5 | 27.5 | | | 28.2 | 28.2 | 28.2 |
| sunflower oil | | | | | | | | |
| Lecithin | — | 0.2 | 0.2 | 0.2 | 0.2 | 0.2 | 0.2 | 0.2 |
| Emulsifier | — | SolmanS- | POEM DS | | | | POEM | ER290 |
| (trade name) | | 300V | 100A | | | | O80V | |
| Amount | — | 0.5 | 0.5 | | | | 0.5 | 0.5 |
| added | | | | | | | | |
| Manufacturer | — | Riken | Riken | | | | Riken | Mitsubishi- |
| | | Vitamin | Vitamin | | | | Vitamin | Chemical |
| | | | | | | | | Foods |
| | | | | | | | | Corporation |
| Emulsifier | — | Monostearate | Distilled | | | | Sorbitan | Sugar ester |
| classification | | (sorbitol) | diglycerin | | | | monooleate | |
| | | | monostea | | | | | |
| HLB | — | 5.3 | 7.7 | | | | 4.9 | About 2 |
| Hydroxyl | — | 315-345 | | | | | 193-209 | |
| value | | | | | | | | |
| (sorbitan) | | | | | | | | |
| Total | — | 100.0 | 100.0 | 100.0 | 100.0 | 100.0 | 100.0 | 100.0 |
| Oil content | — | 33.3 | 33.3 | 25.4 | 30.6 | 34.0 | 34.0 | 34.0 |
| (weight %) | | | | | | | | |
| Melting | — | 9° C. | 9° C. | 11° C. | 36° C. | 9° C. | 9° C. | 9° C. |
| point in oil | | | | | | | | |
| phase | | | | | | | | |
| Viscosity | — | 39.00 | 45.50 | It was not | 45.00 | 40.50 | 32.50 | 17.00 |
| (Pa · s) at | | | | possible to | | | | |
| 40° C. | | | | measure | | | | |
| | | | | because it | | | | |
| | | | | was too high | | | | |
| Yield value | — | 41.24 | 48.08 | 58.06 | 35.21 | 24.97 | 29.90 | 11.45 |
| (Pa) at 40° C. | | | | | | | | |
| Plastic | — | 0.99 | 1.11 | 15.54 | 1.70 | 3.42 | 1.40 | 1.00 |
| viscosity | | | | | | | | |
| (Pa · s) | | | | | | | | |
| Yield | — | 41.66 | 43.32 | 3.74 | 20.71 | 7.30 | 21.36 | 11.45 |
| value/plastic | | | | | | | | |
| viscosity | | | | | | | | |

(Unit in formulation is weight %)

The viscosity of Comparative Example 10 was 50 Pa·s or more, which was not possible to measure.

TABLE 4
Results

| | | | Comparative | Comparative | Comparative | Comparative | Comparative |
|---|---|---|---|---|---|---|---|
| | Example 6 | Example 7 | Example 10 | Example 11 | Example 12 | Example 13 | Example 14 |
| Heat | 5 | 5 | 5 | 5 | 1 | 1 | 1 |
| resistance | | | | | | | |
| evaluation | | | | | | | |
| (40° C.) | | | | | | | |
| Heat | 5 | 5 | 5 | 5 | 1 | 1 | 1 |
| resistance | | | | | | | |
| evaluation | | | | | | | |
| (50° C.) | | | | | | | |
| Heat | 4 | 4 | 5 | 3 | 1 | 1 | 1 |
| resistance | | | | | | | |
| evaluation | | | | | | | |
| (60° C.) | | | | | | | |
| Heat | 4 | 4 | 4 | 2 | 1 | 1 | 1 |
| resistance | | | | | | | |
| evaluation | | | | | | | |
| (70° C.) | | | | | | | |
| Melting | 3 | 3 | 2 | 1 | 3 | 3 | 3 |
| feeling in | | | | | | | |
| the mouth | | | | | | | |

### Conclusions

As in Comparative Example 10, when an oil content was reduced, it was possible to impart heat resistance, but workability significantly deteriorated. Therefore, here it was confirmed that it was difficult to solve the problems of the present invention.

### Comparative Example 10

It was confirmed that, regardless of types of fats and oils, oily foodstuffs containing a predetermined fatty acid ester screened by measuring physical properties has both heat resistance and melting feeling in the mouth and also has excellent workability during preparation.

1. A paste-like oily foodstuff comprising:
an oil content of 26 to 70 weight %, and
an emulsifier,
wherein the paste-like oily foodstuff has, at 40° C., a yield value of 32 to 60 Pa, a plastic viscosity of 0.3 to 1.3, and yield value/plastic viscosity of 30 to 70.

2. The paste-like oily foodstuff according to claim 1, wherein the oil content is 26 to 40 weight %.

3. The paste-like oily foodstuff according to claim 1, wherein the yield value is 37 to 50 Pa.

4. The paste-like oily foodstuff according to claim 1, wherein the plastic viscosity is 0.5 to 1.

5. The paste-like oily foodstuff according to claim 1, wherein yield value/plastic viscosity is 38 to 60.

6. The paste-like oily foodstuff according to claim 1, wherein the oil content is 26 to 40 weight %, the emulsifier is contained, and at 40° C., the yield value is 37 to 50 Pa, the plastic viscosity is 0.5 to 1, and yield value/plastic viscosity is 38 to 60.

7. The paste-like oily foodstuff according to claim 1, wherein the emulsifier is a sorbitol type sorbitan mono fatty acid ester having an HLB of 5 to 10, which is contained at 0.2 to 2.5 weight %.

8. The paste-like oily foodstuff according to claim 7, wherein a fatty acid of the sorbitol type sorbitan mono fatty acid ester is a saturated type.

9. The paste-like oily foodstuff according to claim 1, wherein the emulsifier is a distilled diglycerin mono fatty acid ester having an HLB of 5 to 10, which is contained at 0.2 to 5 weight %.

10. A method of preparing a paste-like oily foodstuff in which a sorbitol type sorbitan mono fatty acid ester having an HLB of 5 to 10 is contained at 0.2 to 2.5 weight %, an oil content is 26 to 70 weight %, and at 40° C., a yield value is 32 to 60 Pa, a plastic viscosity is 0.3 to 1.3, and yield value/plastic viscosity is 30 to 70.

11. The method of preparing a paste-like oily foodstuff according to claim 10,
wherein the sorbitol type sorbitan mono fatty acid ester having an HLB of 5 to 10 is contained at 0.2 to 2.5 weight %, the oil content is 26 to 40 weight %, and at 40° C., the yield value is 37 to 50 Pa, the plastic viscosity is 0.5 to 1, and yield value/plastic viscosity is 38 to 60.

12. The method of preparing a paste-like oily foodstuff according to claim 10,
wherein a fatty acid of the sorbitol type sorbitan mono fatty acid ester is a saturated type.

13. A method of preparing a paste-like oily foodstuff in which a distilled diglycerin mono fatty acid ester having an HLB of 5 to 10 is contained at 0.2 to 5 weight %, an oil content is 26 to 70 weight %, and at 40° C., a yield value is 32 to 60 Pa, a plastic viscosity is 0.3 to 1.3, and yield value/plastic viscosity is 30 to 70.

14. The method of preparing a paste-like oily foodstuff according to claim 13,
wherein a distilled diglycerin mono fatty acid ester having an HLB of 5 to 10 is contained at 0.2 to 5 weight %, the oil content is 26 to 40 weight %, and at 40° C., the yield value is 37 to 50 Pa, the plastic viscosity is 0.5 to 1, and yield value/plastic viscosity is 38 to 60.

15. (canceled)

16. (canceled)

17. (canceled)

18. (canceled)
